(19) United States
(12) Patent Application Publication
(10) Pub. No.: US 2008/0183527 A1
(43) Pub. Date: Jul. 31, 2008

(54) METHOD AND APPARATUS FOR DESIGNING AND PLANNING OF WORKFORCE EVOLUTION

(76) Inventors: Brenda Lynn Deitrich, Yorktown Heights, NY (US); David Gamarnik, New York, NY (US); Mary Elizabeth Helander, Brookline, MA (US); Mark Steven Squillante, Pound Ridge, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 12/052,095

(22) Filed: Mar. 20, 2008

Related U.S. Application Data
(63) Continuation of application No. 10/725,338, filed on Dec. 2, 2003.

(51) Int. Cl. G06Q 10/00

(52) U.S. Cl. 705/7

(57) ABSTRACT

Mathematical means and methods are used within the context of mathematical models of a workforce evolution to address key issues in workforce design and planning. Examples of such mathematical means and methods are (but not limited to) fluid-flow models and diffusion-process models. In each case, these mathematical models characterize the workforce evolution over time as a function of dynamic workforce events, such as new hires, terminations, resignations, retirements, promotions and transfers, and dynamic workforce topology, such as the viable paths from one workforce resource state to another workforce resource state.

### BACKGROUND OF THE INVENTION

1. Field of the Invention

The present invention generally relates to workforce management in business and, more particularly, to a method and apparatus for the continual design and planning of workforce evolution over time. The invention, while completely general, especially addresses the key issues involved with large workforces and/or with workforces whose evolution occurs at a relatively coarse time scale.

2. Background Description

Any business that consists in part of a non-negligible workforce, e.g., a small, medium or large business having several or many employees, requires continual design and planning of the evolution of the workforce over time. Employees are hired, promoted, transfer, resign, retire or are fired. Each employee brings a different skill set to the job and develops additional skills on the job. As a business grows, there is a need for additional employees and, depending on the nature of the growth of the business, employees to fill newly created jobs requiring skill sets not available within the pool of existing employees.

The management and planning of employee requirements is a problem for even small enterprises, and this problem grows as the business grows. Whole departments are devoted to personnel management (sometimes called human resources), but the ability to manage effectively the design and planning of workforce evolution of the enterprise is generally a matter of the individual experience and skill of the person assigned the tasks. That experience and skill varies greatly from individual to individual.

### SUMMARY OF THE INVENTION

It is an object of the present invention to provide an analytical way to model and compute achievable states of the workforce over defined time periods.

According to the invention, mathematical means and methods are used within the context of mathematical models of a workforce evolution to address key issues in workforce design and planning. Examples of such mathematical means and methods are (but not limited to) fluid-flow models and diffusion-process models. In each case, these mathematical models characterize the workforce evolution over time as a function of dynamic workforce events, such as new hires, terminations, resignations, retirements, promotions and transfers, and dynamic workforce topology, such as the viable paths from one workforce resource state to another workforce resource state. The characteristics of dynamic workforce events can vary over time for a number of reasons, e.g., they can vary with economic and business conditions, and the dynamic workforce topology may also vary, both of which are captured by the invention. In addition to modeling the workforce evolution over time, the invention provides the ability to continually optimize and control the various dynamic workforce events in order to achieve some set of objectives, such as future targets for certain workforce resources and levels. As part of doing so, the invention incorporates the concept of a function of the state which can be an indicator of a value of being in this state. Examples of such functions include costs, rewards, penalties, profits, revenues, and others. For example, there can be a cost of maintaining each workforce resource in its current position/category, the concept of rewards, in which there can be a reward for having a resource in a specific position/category, and the concept of penalties, in which there can be a penalty for not having workforce resources available at some point in time with respect to missed opportunities.

The invention makes it possible to answer questions examples of which include: What is the best topology of the workforce evolution model under a certain set of constraints on the topology? What is the total cost of the workforce over a given time frame under a given policy for dynamic workforce events including hiring, attrition and promotion decisions? What is the total profit of the workforce over a given time frame under a given policy of dynamic workforce events including hiring, attrition and promotion decisions? What is the optimal workforce policy to minimize the cost of moving the current workforce state to a target state by a specific time epoch, possibly with a given constraint on profit and/or penalties? What is the optimal workforce policy to maximize the profit of moving the current workforce state to a target state by a specific time epoch, possibly with a given constraint on cost and/or penalties?

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a diagram showing the general modeling concept of the transitions of a person in a role and/or skill level in the workforce;

FIG. 2 is a diagram, similar to FIG. 1, showing a specific modeling example from hiring to termination of a person in the workforce;

FIG. 3 is a diagram, similar to FIG. 2, showing a modeling example which includes branching to a different role and/or skill level by way of promotion;

FIG. 4 is a diagram, similar to FIG. 3, showing an alternative entry into a role and/or skill level by way of promotion;

FIG. 5 is a diagram, similar to FIG. 4, but showing an alternative entry into a role and/or skill level by way of demotion;

FIG. 6 is a diagram showing more generally the transitions of multiple persons in the workforce;

FIG. 7 is a diagram, similar to FIG. 6, generalized to show transitions of any number of persons in the workforce;

FIG. 8 is a diagram showing the modeling of a role shift of a person in the workforce;

FIG. 9 is a diagram combining the modeling of FIGS. 7 and 8;

FIG. 10 is a diagram, similar to FIG. 9, which models the possibility of a role shift with a demotion;

FIG. 11 is a diagram, similar to FIG. 10, which models the possibility of a role shift with a promotion;

FIG. 12 is a table showing roles (positions) and skill levels of a particular type of workforce;

FIG. 13 is a diagram showing a hierarchy of roles and skills modeling the type of workforce shown in tabular form in FIG. 12;

FIG. 14 is a block diagram showing the architecture and data flow of the system according to the invention for solving the workforce model;

FIG. 15 is a block diagram, similar to FIG. 14, in which the system is divided into to specific layers; and

FIG. 16 is a flow diagram showing the logic of the process implemented on the system shown in FIG. 15.

### DETAILED DESCRIPTION OF A PREFERRED EMBODIMENT OF THE INVENTION

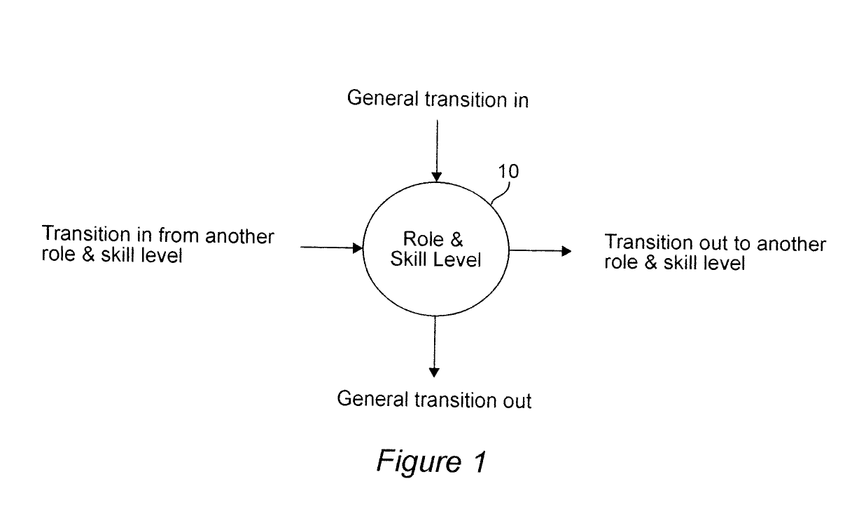

Referring now to the drawings, and more particularly to FIG. 1, there is shown a diagram of the abstract modeling concept of the invention. A workforce evolution network is comprised of individual elements which provide the combined value of the network. The main example of such elements is an employee or a group of employees. An employee is associated with some characteristics of employment. The example of such characteristics is a combination of a definable role and skill level 10 at a specific point in time. There are suitable transitions among said characteristics which are either intra- or inter-workforce events. Below we provide some examples of such suitable transitions. The role and skill level 10 is entered either by a general transition in, e.g., the person was hired for the job, or by a transition in from another role and skill level, e.g., the person was transferred from another position in the company. The hiring is an example of an inter-workforce event and transferring is an example of an intra-workforce event. The role and skill level 10 is exited either by a general transition out, e.g., the person resigns, retires or is fired, this being an example of an inter-workforce event, or by a transition out to another role and skill level, e.g., the person is transferred to another position in the company, this being an example of an intra-workforce event.

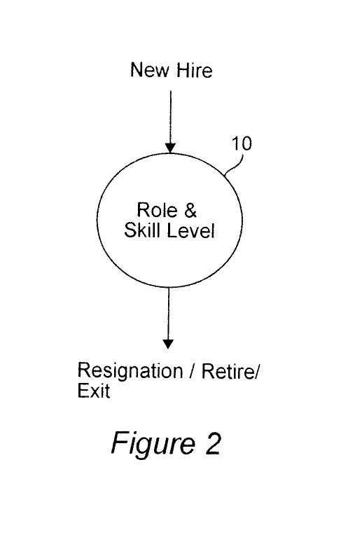

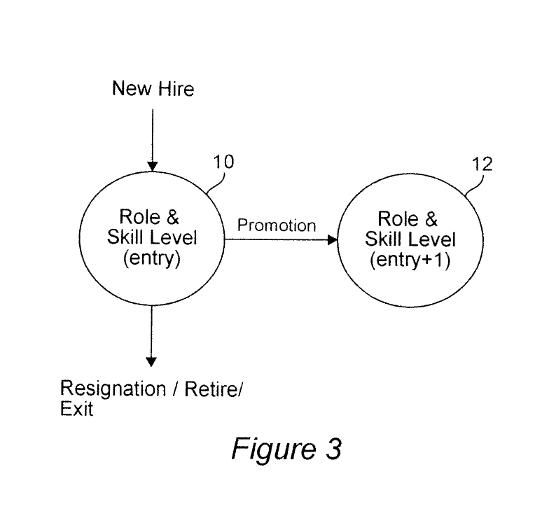

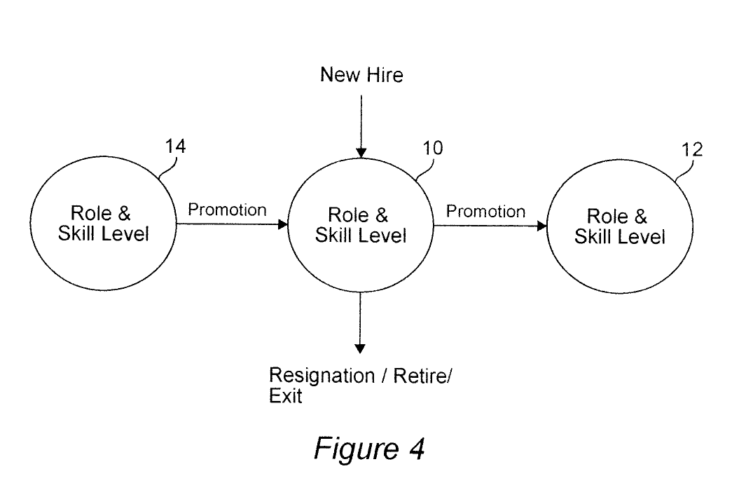

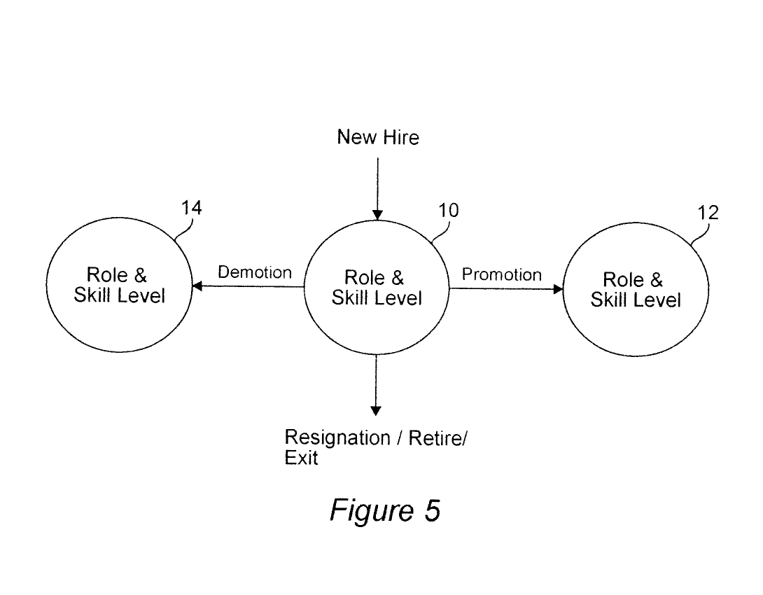

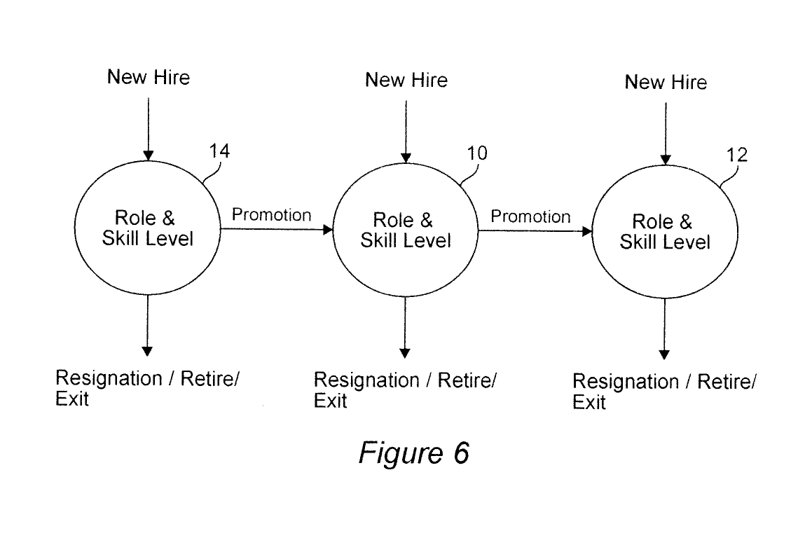

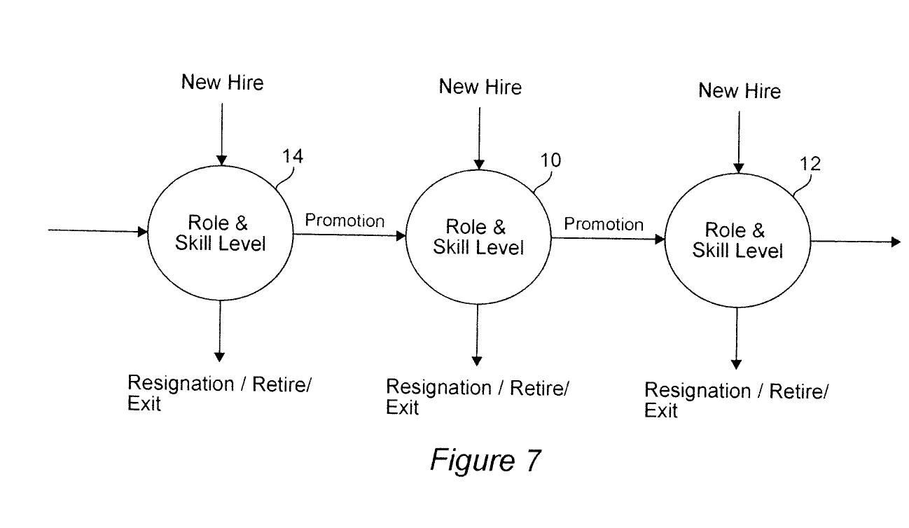

FIG. 2 shows just the vertical progression of FIG. 1; that is, the transition in by hiring to the transition out by resignation, retirement or termination. FIG. 3 adds a variation in the horizontal direction in which the individual is promoted to a new role and skill level 12. FIG. 4 adds a second variation in which the individual is promoted from a lesser role and skill level 14 to the current role and skill level 10 with the prospect for a future promotion to the role and skill level 12. A variation on the theme of FIG. 4 is the possibility that a person in the role and skill level 10 could be demoted to the role and skill level 14, as shown in FIG. 5. As shown in FIG. 6, each roll and skill level, 10, 12 and 14 could be entered by way of hiring and exited by way of resignation, retirement or termination. And FIG. 7 illustrates that this may be a continual progression, depending of course on the size of the organization.

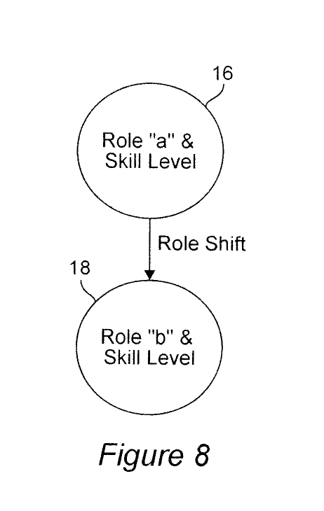

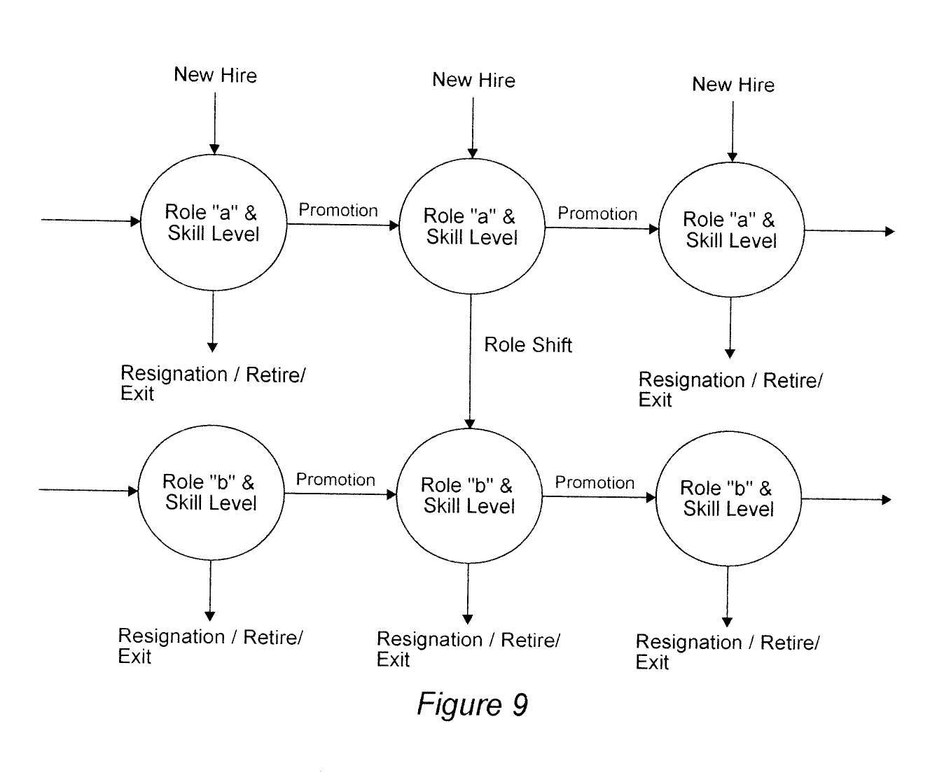

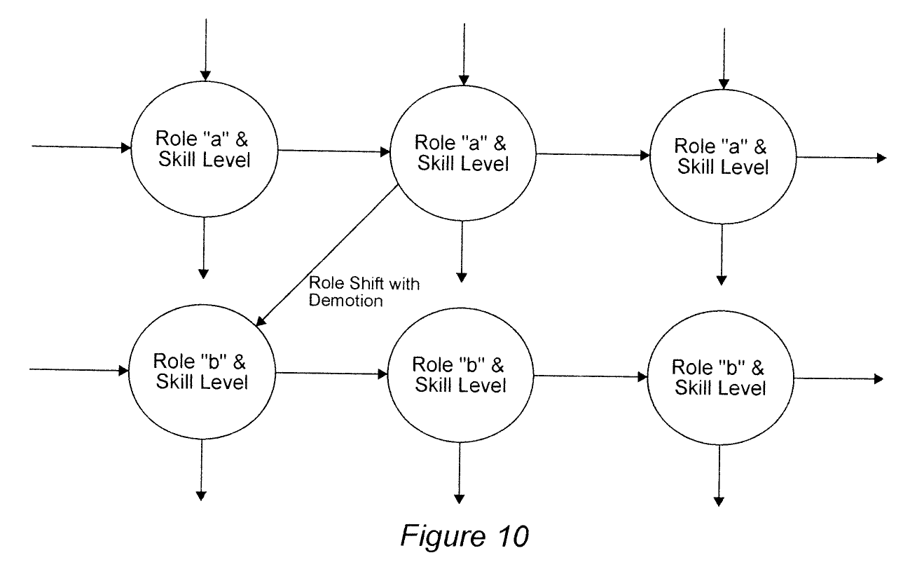

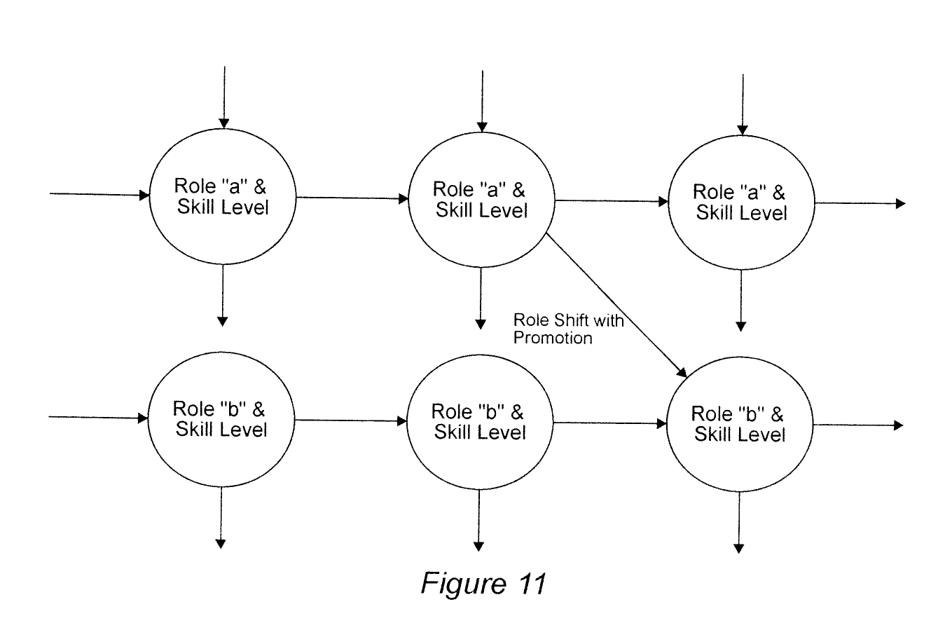

A further possibility not contemplated by the foregoing illustrations is that shown in FIG. 8. Specifically, a person in a first role, here called role “a”, and skill level 16, may be shifted to a second role, here called role “b” and skill level 18. This may result from on the job training, additional education or a new need arising within the organization, for example. Now, combining the concepts of FIGS. 7 and 8 results in the diagram of FIG. 9 which illustrates two parallel tracks, one of which may be entered by a role shift. A variation is shown in FIG. 10 in which the role shift is accompanied by a demotion and, correspondingly, in FIG. 11 in which the role shift is accompanied by a promotion.

FIGS. 1 to 11 illustrate the modeling concept of the present invention. The invention provides a method and apparatus for modeling as well as computing the achievable states of the workforce evolution network for a given one or multiple defined time periods, as well as determining whether a target or desirable state(s) is (are) achievable with the given present state and with the given rates per period for each link into, from or between one of several groups of employees which correspond to the same employment characteristics, for example, skill level/job role groups (hereinafter skill level/job group).

A workforce evolution network is comprised of the following elements: workforce evolution topology, present state, time periods, workforce evolution rates, space of controlled evolution rates, cost(s), penalties, value and/or reward function of operating a workforce evolution network. In a process of modeling a workforce evolution network the user of the invention needs to identify some or all of these elements.

The workforce evolution network topology is comprised of two or more skill level/job groups and viable paths between these groups. The viable paths represent the inter or intra type transitions between the skill level/job groups of employees and are represented by one or more directed links. Each link is either an inward link toward one of the skill level/job groups or an outward link from one of the skill level/job group, or a link between exactly two skill level/job groups. The skill level/job groups together with links constitute the topology of the workforce evolution network. Examples of particular topologies are tree, grid, star, cluster, etc. The present invention is not limited by any particular class of topologies. The present invention provides a method for comparing and identifying the most suitable topology among a collection of topologies against a mix of workforce topological internal and external constraints, whenever some value function is associated with each topology. For example if there is a fixed cost per link R associated with each link of the network, then the least expensive topology can be computed by taking the minimum over the RL, where minimum is taken with respect to the space of topologies satisfying the constraints, and L represents the number of links in the selected topology.

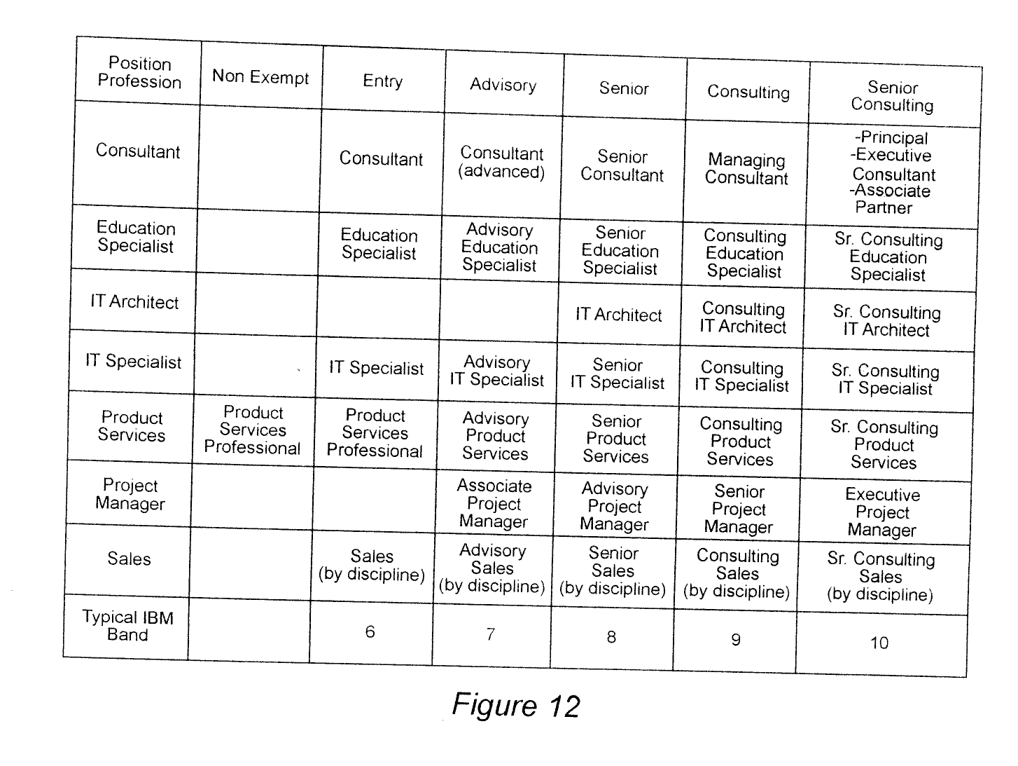

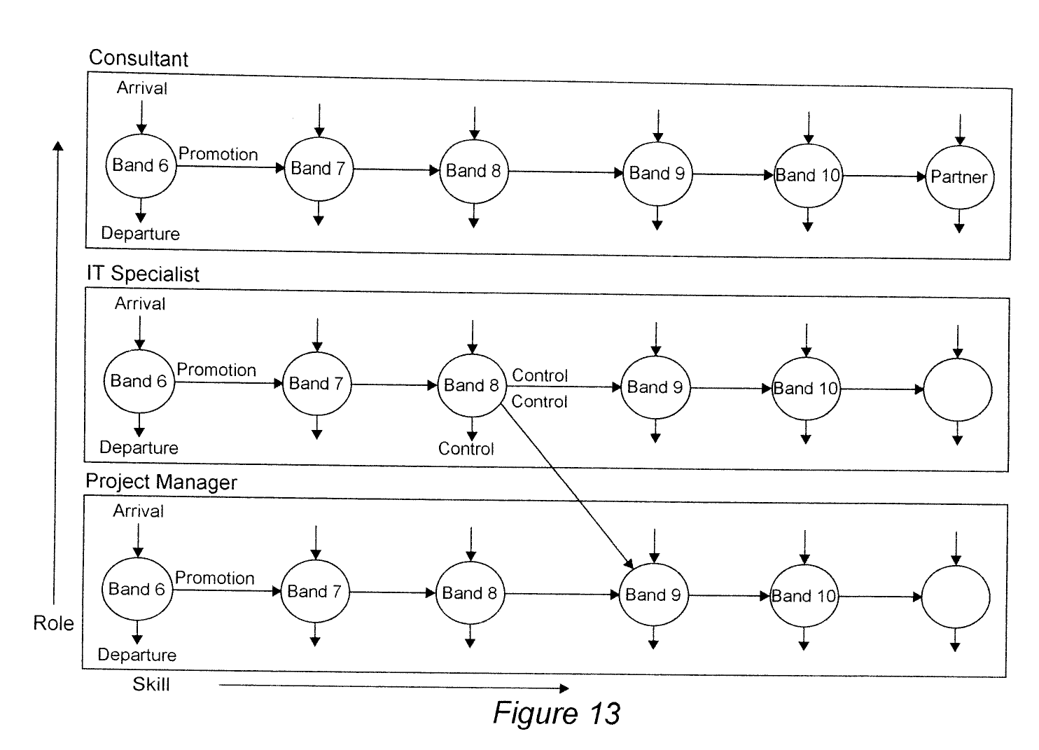

A skill level/job group is a group of persons identified by the combination of a particular level of skills a person possesses and the job (assignment) that the person is expected to execute as expected from his/her employment position. FIG. 12 is a table listing various positions and skill levels in the field of Information Technology (IT). FIG. 13 is a diagram, similar to FIG. 11, which shows the skill level/job group for the positions of consultant, IT specialist and project manager from the table in FIG. 12. This is but one example in one field, and the invention may be applied to any workforce. For example, paralegal specialist and lawyer represent two different skill levels in the area of law, various level of certification of network engineering are examples of skill levels in the information technology area, analyst and senior analyst are examples of skill levels in the domain of financial analysis. The second component of a skill level/job group is the job role that the employee is executing per his/her employment expectations. Examples are say a lawyer in a law firm (with possibly more refined job roles corresponding to say partnership status), system administrator and project manager are examples of job roles in the information technology area, portfolio manager is an example of a job role in the finance area.

A Link in the workforce evolution network topology is a representation of transitions to, from, or between one or more skill level/job groups (see FIGS. 1 to 11). The workforce evolution network may contain the any type of a link, with following types being common examples: new hire link, resignation/retire/layoff/fire link, promotion link, demotion link, role shift link, role shift with promotion link, role shift with demotion link. The links do not represent a particular instance of hiring, retiring, promotion or other types of transition, nor do they represent particular time(s) of transitions, rather they represents a generic process of transitions into/from/between specified skill level/job group(s).

A new hire link into a skill level/job group say “A” (see FIG. 2) represents the process of hiring new employee(s) from outside of the scope of the group of employees identified by the workforce evolution network, into the group “A” as occurring over time. There is a link of this type into group “A” as long as hiring is possible into the group “A”. For every skill level/job group of a workforce evolution network into which hiring is possible there corresponds exactly one link pointing into this group.

A resignation/retire/layoff/fire link from a skill level/job group say “A” (see, again, FIG. 2) represents a process of resigning/retiring of an employee(s) of group “A” or laying off or firing of an employee(s) from group “A”. For every skill level/job group of a workforce evolution network from which the process of resignation/retiring/laying off/firing is possible there corresponds exactly one link pointing away from the group.

The promotion link is a link between two skill level/job groups say groups “A” and “B” (see FIGS. 3 and 4) and represents the process of promoting an employee(s) from group “A” to group “B”. For every two groups of workforce evolution network between which such a process of promotion is possible, a promotion link is present. The link originates from the group “A” and points to the group “B”, if the process of promotion is possible from “A” into “B”.

The demotion link is link between two skill level/job groups say groups “A” and “B” (see FIG. 5) and represents the process of demoting employee(s) from the group “A” to the group “B”. For every two groups of the workforce evolution network between which such a process of demotion is possible, the demotion link is present. The link originates from the group “A” and points to the group “B”, if demotion of an employee is possible from the group “A” into the group “B”.

The role shift link is a link between two skill level/job groups say groups “A” and “B” (see FIGS. 8 and 9) which correspond to the same skill level but different job roles. Such a link represents the process of employee(s) shifting the job role they execute and transitioning from group “A” to group “B” as a consequence of a job role shift, while maintaining the same skill level. For every two groups of workforce evolution network between which such a process of role shift is possible, the role shift link is present. The link originates from the group “A” and points to the group “B”, if it is possible to shift a job role corresponding to group “A” into job role corresponding to group “B”, while maintaining the same skill level.

The role shift with promotion link (see FIG. 11) is a link between two skill level/job groups say groups “A” and “B” which correspond to different skill levels and different job roles. Such a link represents the process of promoting an employee(s) and shifting the job role they execute. For every two groups of workforce evolution network between which such a process of role shift and promotion is possible, the role shift with promotion link is present. The link originates from the group “A” and points to the group “B”, if it is possible to shift a job role corresponding to group “A” into job role corresponding to group “B”, while changing the skill level corresponding to the group “A” to the skill level corresponding to the group “B”.

The role shift with demotion link (see FIG. 10) is link between two skill level/job groups say groups “A” and “B” which correspond to different skill levels and different job roles. Such a link represents the process of employee(s) shifting the job role they execute and being demoted, resulting in transitioning from the group “A” to the group “B”. For every two groups of a workforce evolution network between which such a process of role shift and demotion is possible, the role shift with demotion link is present. The link originates from the group “A” and points to the group “B”, if it is possible to shift a job role corresponding to group “A” into job role corresponding to group “B”, while changing the skill level corresponding to the group “A” to the skill level corresponding to the group “B”.

An optimal topology for a workforce evolution network is understood as any network topology which results in the lowest possible cost of the workforce network and which satisfies the necessary constraints on the topology. The method for determining the optimal topology of a workforce evolution consists of the following steps:
1. Formulating a workforce evolution model.
2. Identifying the constraints on the topology. Examples of such constraints are: the network must be a cluster, the network must be a connected graph, the network must contain at least so many layers, etc.
3. Identifying the cost as a function of the topology. The cost is understood as any function of the topology.
4. Identification of the optimal topology by finding the topology which minimizes the cost among the space of topologies satisfying the constraints.

The present state of a workforce evolution network is represented by the number of employees in each skill level/job group at a given specified time. This time is not necessarily the time at which the execution of the tool is conducted; rather, it is any time starting from which the evolution of the workforce network needs to be analyzed. The combination (vector) of these numbers constitutes the state of the network at the given time. For example if the workforce network consists of exactly three skill level/job groups “A”, “B”, “C” and at nominally present time “t” (for example Jan. 20, 2002) there were 1000, 1200 and 1400 employees in groups “A”, “B”, “C”, respectively, then the state of the workforce network at time “t” is (1000, 1200, 1400), where the first, second and third number represent the number of employees in groups “A”, “B”, “C” in this order.

Time periods are intervals of time over which the workforce evolution model is analyzed or designed or controlled or managed or optimized. Each time period is represented by a pair of time instances t′,t″ with t′ not exceeding t″. An example of a time period is (01/20/2002, 01/20/2003) which represents a time period between Jan. 20, 2002 and Jan. 20, 2003.

The workforce evolution rates are numeric values associated with transition links (links) of the workforce evolution topology and with time period(s). One transition rate is associated with one pair (link, time period). The transition rate is designed to represent the rate at which the transition of employees occurs over the specified link over the specified time period. The rate can be numerically represented either by a fixed number or by a probability distribution.

If a rate corresponding to some (link, time period) pair (l(t′,t″)) is a number, this number represents the rate with which the transition occurs in the link l over the time period (t′,t″) per some specified unit of time. For example if link l corresponds to a new hire type link into a skill level/job group “A”, and a time period is (01/20/2002, 01/20/2003), then the rate r=150 for this pair represents the fact that there are 150 new hires per unit of time (say month) into group “A” which occur over the time interval (01/20/2002, 01/20/2003) (that is, 12 months). The present invention is not limited in terms of which units are used for the rates. For example, the rates can be specified in hundreds of employees and time units could be days or years.

If a rate corresponding to a (link, time period) pair (l,(t′,t″)) is a probability distribution function, this function represents the probability distribution with which the transition occurs over the link l over the time period (t′,t″). For example, if the link l corresponds to a new hire type link into a skill level/job group “A”, and a time period is (01/20/2002, 01/20/2003), then for this pair the rate r could be represented as r(100)=%50, r(110)=%20, r(130)=%30, meaning with probability %50 there are 100 hires into group “A”, with probability %20 there 110 hires into group “A” and with probability %30 there are 130 hires into group “A”. The present invention is not limited in terms of which units are used for the rates, what type of distribution functions are used for the rates as well as whether the distribution function representing the rate is discrete or continuous.

Space of controlled evolution rates is one or more workforce evolution rates for each pair of skill level/job group and a time period. The space is specified for each such pair and represents different evolution rates that can be implemented to be realized in the workforce evolution network. For example, for a pair (l,(t′,t″)) of a link l and a time period (t′,t″), the space (r1,r2,r3,r4) represents four different evolution rates which can be realized as a part of the control execution for the link l and a time period (t′,t″). The present invention is not limited in the size of the space (the number of different evolution rates), in the type of the space (discrete versus continuous); likewise, it is not limited in whether the elements of the space are numbers or probability distributions or mixtures of numbers and probability distributions.

The states of the workforce evolution network can be associated with some function which can represent some measure of interest. The examples of such include functions include (but are not limited to) cost, penalties, reward, revenue, profit, and others.

The cost of running a workforce evolution network is one or more numerical values associated with maintaining the evolution network in a particular states at a particular time and is represented as a cost function. For example, the cost could be a correspondence of a state of a workforce evolution network to a some dollar amount which reflects the cost of maintaining this state (the cost of having so many employees in each of the skill level/job group) per unit of time. The cost can be a different function depending on a time period or could be the same function for all time periods. The present invention is not limited in terms of particular type of costs or cost functions, discrete versus continuous cost functions and units of measurements for costs or times.

The penalties corresponding to running a workforce evolution network is one or more numerical values associated with maintaining the evolution network in a particular states at a particular time and is represented as a penalty function. The penalty function is designed to model for example the lost revenue/profit due to being in a particular state. For example, if the profit corresponding to the state A for the time instance t is $10M and the demand for the time instance t was $15, then the penalty corresponding to the state A is $5M. The value and reward functions are understood similarly.

The present invention provides a method and apparatus for computing the achievable states of the workforce evolution network as well as computing the feasibility of getting into a target state(s). Such a method is useful for addressing for example the following type of questions: given the present state of the network, given the evolution rates and the one of multiple time periods (time horizon) will there be more than X specialists in the group(s) corresponding to the skill level L?

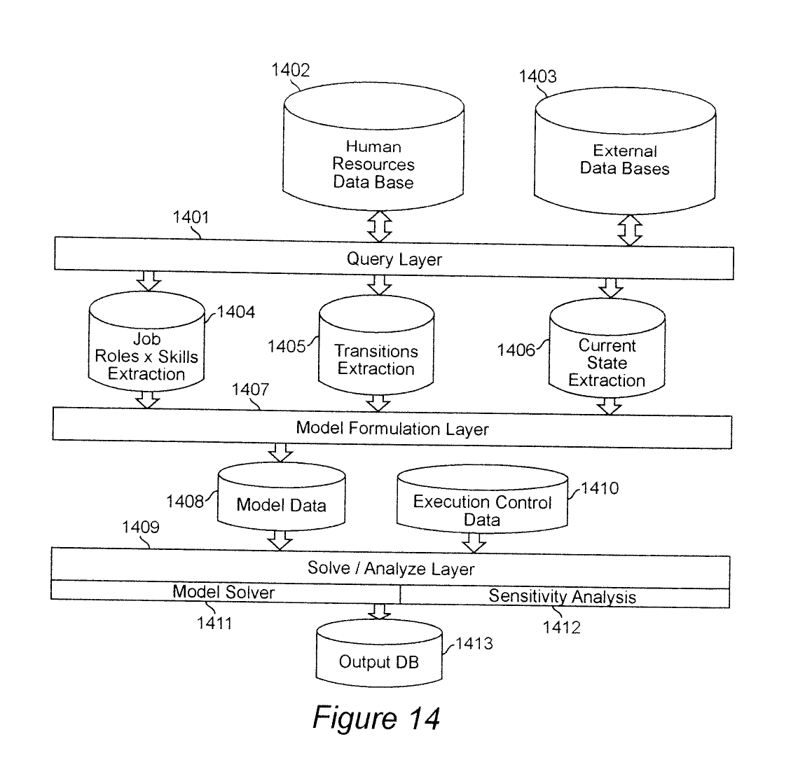

FIG. 14 shows the system solution architecture which implements the present invention. The architecture may be characterized as comprising several layers separated by databases and computational and execution functions. The first layer is the query layer 1401 which accesses a human resources data base 1402 and other external data bases 1403. These data bases are accessed through the query layer 1401 by a job extraction function 1404, a transitions extraction function 1405, and a current state extraction function 1406. The outputs of these three functions are supplied to the model formulation layer 1407. The data from the model formulation layer 1407 is stored in the model data base 1408. The solve/analyzer layer 1409 accesses the data in the model data base 1408 and execution control data 1410. The solve/analyze layer 1409 includes a model solver 1411 and a sensitivity analysis function 1412. The output of the solve/analyze layer 1409 is output to the output data base 1413.

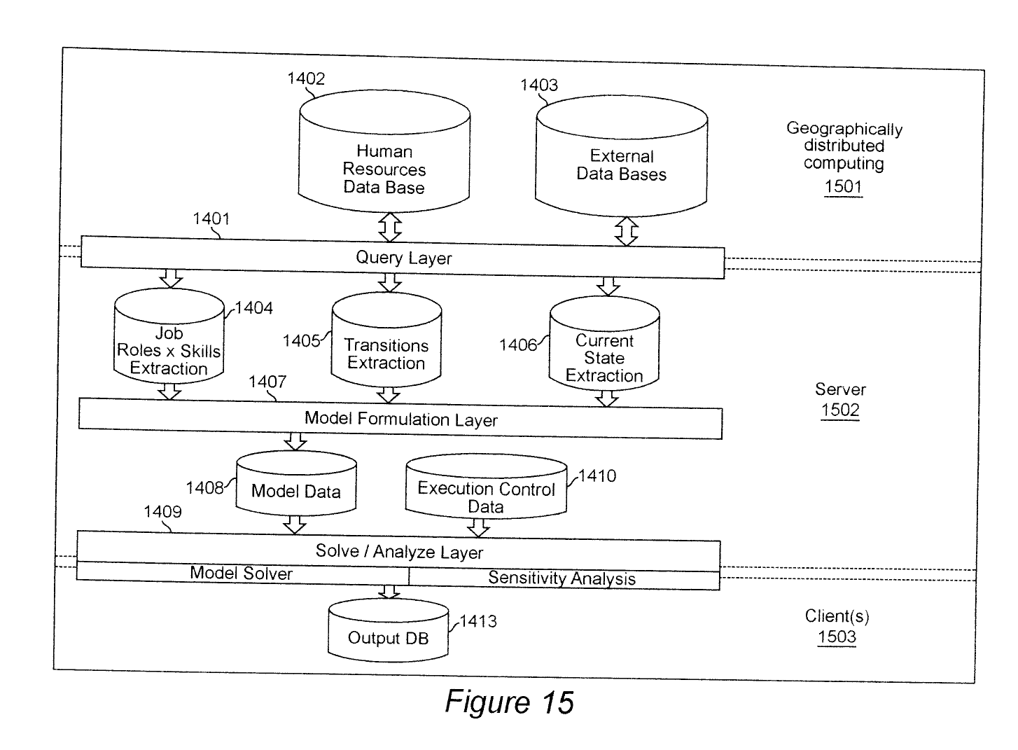

FIG. 15 shows how the architecture of FIG. 14 is divided by task among an enterprise computing system. More particularly, the human resources data base 1402 and the external data bases 1403 are part of a geographically distributed computing network 1501, accessible, for example, via the Internet. The query layer 1401 therefore includes a search engine. The job extraction function 1404, the transitions extraction function 1405, the current state function 1406, the model formulation layer 1407, the model data base 1408, the execution control data 1409, and the solve/analyze layer 1410 are implemented on the server 1502 of the enterprise computing system. Finally, the output of the data base 1413 is implemented on client(s) 1503 of the enterprise computing system. Note that the query layer 1401 separates the geographically distributed computing network 1501 from the enterprise server 1502, and the solve/analyze layer 1409 separates the enterprise server 1502 and client(s) 1503.

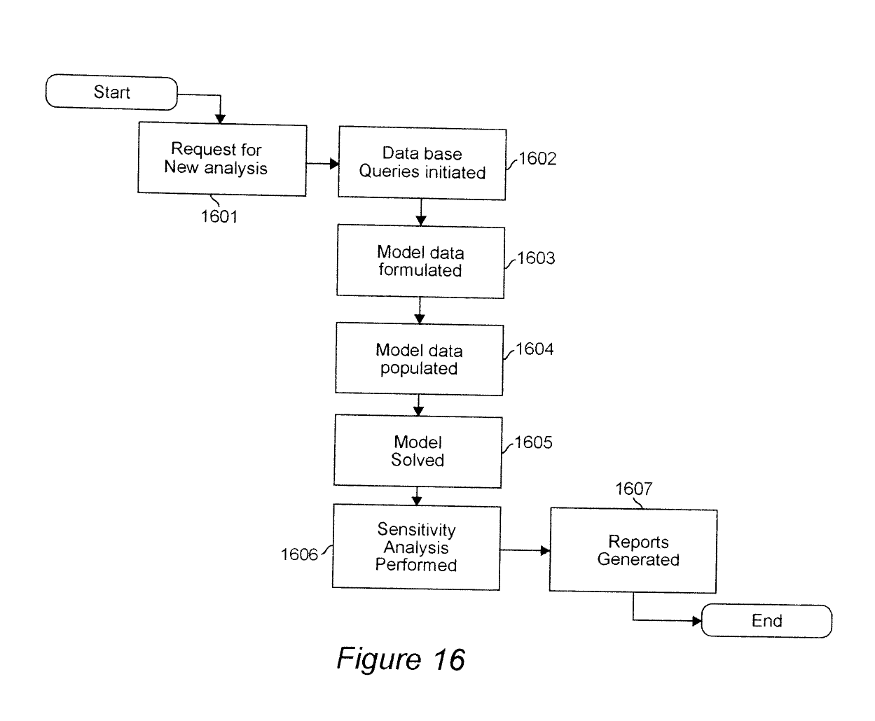

Briefly described, the method according to the invention implemented on the computing system shown in FIGS. 14 and 15 is shown in FIG. 16. The process begins in function block 1601 when a request for a new analysis is received. This initiates data base queries in function block 1602. The data accessed from the human resources data base 1402 and the external data bases 1403 are used formulate model data in function block 1603 and to populate model data in function block 1604. The model so formulated and populated is then solved in function block 1605. A sensitivity analysis is then performed in function block 1606, and reports are generated in function block 1607.

The method comprises the following steps:

First, Computing the Achievable States which involves
Formulating a workforce evolution model,
Identifying one or more time periods of interest,
Populating the model with evolution rates data,
Identifying the present state, and
Computation of achievable state(s).

Identifying the Feasibility of Target States, in which the first four steps of the process are the same as the ones for Computing the Achievable States plus:
Identifying the target state(s),
Computing the achievable states using the method Computing the Achievable States described above, and checking whether the achievable state(s) is (are) one of the target states, and
Identifying the space of controlled evolution rates and computing elements of the space of controlled evolution rates, which after implementation would result in one of the target state(s), or identifying that no such element of the space of controlled evolution rates exists.

The first step in Computing the Achievable States corresponds to the workforce evolution network modeling as generally described above. As a result of this step, the workforce evolution network topology is identified. Specifically the skill level/job groups are identified as a well as the links to, from or between one or more skill level/job groups are identified.

In the second step, one or more time periods of interest are identified. For example, for the purpose of computing the achievable states the following three time periods may be selected: (01/20/2001, 06/20/2001), (01/20/2001, 12/31/2001), and (12/31/2001, 06/20/2002). The number of time periods as a well as the duration(s) of time periods is not restricted in any way.

In the third step, for each of the link of the workforce evolution network identified in the first step and for each of the time periods identified in the second step, a query is made into a database(s) in order to obtain the workforce evolution rate corresponding to this combination of a link and a time period.

In the fourth step, the state corresponding to the present time (the beginning of the first of the time periods fixed in the second step) is identified. For each of the skill level/job group a query into a database(s) is made to identify the number of employees in this group at the present time.

In the fifth step, the achievable state(s) are identified. The procedure for computing the achievable states is a process of mathematical computation which can be done in multiple ways.
When the workforce evolution rates identified as described in third step are given as numerical values (and not as probability distribution functions and not as a space of controlled evolution rates) and when exactly one time period was selected in the second step, the computation of the achievable state is obtained in several substeps.
Multiplying each of the transition rate identified in the third step by the duration of the interval.
For each skill level/job group and each link pointing into it, the numerical values obtained are added to the component of the present state corresponding to the selected group.

For each of the skill level/job group and each link pointing away from it, the numerical value obtained is subtracted from the component of the present state corresponding to the selected group.
The resulting numerical value for each of the skill level/job group constitutes the achievable state

When the workforce evolution rates identified as described in the third step are given as numerical values (and not as probability distribution functions or a space of controlled evolution rates) and two or more time period was selected in the second step, the computation of the achievable state is obtained in several substeps.
The first time period from the multitude of selected time periods is identified. The steps described above are performed and, as a result, the achievable state at the end of the first time period is obtained. This achievable state is recorded as a present state.
The process is repeated with the obtained present state and the second time period substituting the first time period, then for the third (if at least three periods are selected) substituting the second, and so on until the computation for the last time period is executed.
The numerical value for each of the skill level/job group obtained constitutes the achievable state.

When the workforce evolution rates as described in the third step are given as probability distribution functions (and not as numerical values, refer to the previous section) and one or more time period was selected in the second step, the computation of the achievable state can obtained in a multitude of ways using several of mathematical computations.

Any appropriate generic mathematical method can be applied towards the goal of computing the achievable state(s). Some of the examples of such methods are as follows:

Fluid models method of computation of the achievable states is a method of computing achievable state(s) of the workforce evolution network using a mathematical technique known as fluid models technique. The computation proceeds in the following steps:
For each of the link of the workforce evolution network and for each of the transition rate of such a link, the expected value corresponding to the distribution function of the evolution rate is computed. For example, if the distribution function for a link l is given as r(100)=%30, r(200)=%60, r(300)=%10, then the expected value is computed as %30×100+%60×200+%10×300=180. This value is recorded as a numerical value of the evolution rate corresponding to the link.
Once the expected value corresponding to the distribution function of the evolution rate is computed is performed for every link and every corresponding evolution rate probability distribution function, the computation of the achievable states is done exactly as described for the case when the evolution rates are provided as numerical values. The computed achievable state(s) is the achievable state(s) corresponding to the fluid model method of computation.

Brownian motion based method of computation of the achievable states. This is a method of computing achievable state(s) of the workforce evolution network using a mathematical concept known as Brownian motion. The computation proceeds in the following steps:
For each of the link of the workforce evolution network and for each of the transition rate for such a link and for each of the time period considered, the expected value and the second moment corresponding to the distribution function of the evolution rate for the given time period is computed. For example, if the distribution function for a link l is given as r(100)=%30, r(200)=%60, r(300)=%10, the expected value is computed as %30×100+%60×200+%10×300=180 and the second moment is computed as
   %30×100²+%60×200²+%10×300²=36,000. Then for each link l, the Brownian model is formulated with drift equal to the expected value and the variance equal to the second moment minus the square of the expectation. The achievable state(s) are computed using this model by computing the state of the Brownian motion at the end of the last time interval. The answer is given in a form of a probability distribution, where for each state or a collections of states, a probability of being in this state(s) is the answer.

Convolution based method of computation of the achievable states is a method of computing achievable state(s) of the workforce evolution network using a mathematical probability method known as convolution. The computation proceeds in the following steps:
A distribution function of the vector of transition rates is constructed for each of the considered time periods using the distribution functions of the rates of individual links corresponding to the time period considered. Then the distribution function of the sum of these vectors (corresponding to all of the time periods) is computed using the method of convolution.
The present state is identified as described in Step 4 and added to the obtained distribution function.

The resulting distribution function provides the distribution function of the achievable state(s) of the workforce evolution network. Using this methodology, the invention enables one to answer the questions of the probabilistic nature. For example, one is able to answer the questions of a form: what is the probability that given the present state and given the sequence of time periods the resulting state is such that the total number of employees in skill level/job group A is less than 2300?

The first four steps of Identifying the Feasibility of Target States are the same as the ones for computing the achievable states. In addition, as a fifth step, one or more target states for the workforce evolution model are specified. As a sixth step, when the evolution rates for the links of the workforce evolution network are given either as numerical values or probability distribution functions (but not as a space of controlled evolution rates) the computation of feasibility of target states consists of first computing the achievable states using the method Computing the Achievable States, described above, and then checking whether the achievable states is (are) one of the target state(s). Then, as a seventh step, when the evolution rates for the links of the workforce evolution network are given as a space of controlled evolution rates, the computation of feasibility of target states can proceed in a multitude of ways.

The exhaustive search is a method of identifying one by one every possible element from the space of evolution rates and checking for each such combination of rates (each combination consists of exactly one evolution rate for each pair of link and time period) whether the target state is achievable using the procedure Computing the Achievable States, described above. If as a result of this computation at least one element of the space of controlled evolution rates is identified which leads to a target state(s), then the feasibility of the target state is established. If not, then the infeasibility of the target state is established.

Optimization methods of identifying the feasibility of target states is a method of using linear, dynamic, stochastic or other methods of mathematical optimization techniques for the goal of identifying the feasibility states. For example, when the evolution rates are given as numeric intervals (say an evolution rate associated with a link L during the time period (01/10/2003, 03/01/2003) is specified to be between 30 and 50 employees), then the problem of identifying the feasibility of target states is formulated as a linear programming problem, where the controlled evolution rates serve as variables of the linear programming problem. By solving this linear programming problem, on checks the feasibility of the target state. In particular, if the linear programming problem is feasible, the feasibility of the target state is verified, and if it is not feasible, the non-feasibility of the target state is verified.

The invention provides a method and apparatus for modeling and computing the cost of operating a workforce evolution network as well as determining the optimal cost of operating such a network and computing a control policy which achieves such optimal cost.

Briefly described, the method for computing the cost of operating a workforce evolution network comprises the following steps:
1. Formulating a workforce evolution model.
2. Identifying one or more time periods of interest.
3. Populating the model with the data.
   3.1. Populating the model with evolution rates data.
   3.2. Populating the model with the cost data.
4. Identifying the present state.
5. Computation of the cost of operating the network over the time period(s) specified in Step 2.

In the first step, the formulation of a workforce evolution model is done exactly as described in the first step of Computing the Achievable States method, described above. In this step, the topology of the workforce evolution network is identified.

The second step is performed in exactly the same manner as the second step of Computing the Achievable States method, described above. As a result of this step one or several time periods of interest are specified.

The third step is performed in exactly the same manner as the third step of Computing the Achievable States method, described above. As a result of this step, the evolution rates (either numerical values, or probability distribution functions or the space of controlled evolution rates) are selected. A query is made into a database in order to obtain the cost function to be used for computing the cost of operating a network.

The fourth step is performed in exactly the same manner as the fourth step of Computing the Achievable States method, described above. That is, for each of the skill level/job group, a query into a database(s) is made to identify the number of employees in this group at the present time (the time corresponding to the beginning of the first of the time periods considered).

In the fifth step, the cost of operating the network over for the selected time periods is computed. The procedure for computing these costs is a process of mathematical computation which can be done in multiple ways. When the transition rates for the links of the workforce evolution network are given by numerical network, the cost of operating the network is obtained as follows:
The achievable states are computed for each end point of the time periods considered. This is performed using the Computing the Achievable States method.
For time period the cost corresponding the achievable state at the beginning and at the end of the period is computed using the cost function. The average of two resulting values is computed and is multiplied by the length of the period.
The averages are summed over all the considered time periods.

Say, for example, two time periods (01/01/2003, 03/01/2003) and (03/01/2003, 09/01/2003) are considered. Say the present state (that is state at 01/01/2003 of the network) is obtained and is denoted generically by A, the state of the network at time 03/1/2003 is denoted generically by B and the state of the network at time 09/1/2003 is denoted generically by C. Say the computation of the cost of the states A, B and C using the cost function results in values $1.2M per month, $1.3M per month and $1.5M per month (usually this would correspond to the increase of the total number of employees in the workforce network). Then the cost of operating the workforce network over the period 01/01/2003-09/01/2003 is (1.2+1.3)/2×3 months+(1.3+1.5)/2×6 months=$3.75M+$8.4M=$12.15M in total dollar amount.

When the transition rates for the links of the workforce evolution network are given by probability distribution functions, the cost of operating the network is obtained in one of the following ways:
Fluid models based method are used for computing the cost. For each of the link of the workforce network and the corresponding probability distribution of an evolution rate, the expected value of the evolution rate is computed as described above for the Computing the Achievable States method. These expected values are then taken as numerical values for the evolution rates and corresponding cost of operating the network is computed.
Convolution method based computation of the cost is a method of computing the cost of operating the workforce evolution network using a mathematical method known as convolution. The computation proceeds as follows. A distribution function of the vector of transition rates is constructed for each of the considered time periods using the distribution functions of the rates of individual links corresponding to the considered time periods. Then a convolution function of these vector distribution functions corresponding to the end of each periods is computed. This computation results in the distribution function of the state of the network at the end of each time period as well as the joint distribution of the state of the system over all the end points of the considered periods. By applying the cost function to the states of the network in the end of the periods (given by the computed distribution functions) one obtains the distribution function of the cost of operating the network over the selected time periods. Using this methodology the invention enables one to answer the questions of the probabilistic nature. For example one is able to answer the questions of a form: what is the probability that given the present state and given the sequence of time periods the cost of operating the workforce network will exceed $10M?

An optimal policy for operating a workforce evolution network is understood as any sequence of elements of the space of controlled evolution rates which results in the lowest possible cost of operating the workforce network. The method for determining the optimal cost of operating a workforce evolution network and determining an optimal policy consists of the following steps:
1. Formulating a workforce evolution model.
2. Identifying one or more time periods of interest.
3. Populating the model with the data.
   3.1. Populating the model with the space of controlled evolution rates data.
   3.2. Populating the model with the cost data.
4. Identifying the present state.
5. Computation of the optimal cost of operating the network over the time period(s) specified in Step 2 and identifying a policy which achieves the optimal cost of operation.

The first four steps are performed in exactly the same manner as for Computing the Cost of Operating a Workforce Evolution Network method, with the exception that in Step 3.1 the space of controlled evolution rates data is loaded from a database. The fifth step computes the optimal cost of operating a workforce network and identifying an optimal policy to achieve this cost can be done in a multitudes of ways.
Enumerative computations method consists of exhaustively considering every element of the space of controlled evolution rates, fixing it as a numerical value for evolution rates and computing the associated cost of operating the network under the considered vector of evolution rates using the method Computing the Cost of Operating a Workforce Evolution Network described above. Identifying a vector of evolution rates which results in the smallest such operating cost solves the problem of computing the optimal cost and finding the optimal policy.
Optimization methods of identifying the optimal cost or operating the workforce network and identifying an optimal policy use linear, dynamic, stochastic or other methods of mathematical optimization techniques for the goal of identifying the optimal cost and an optimal policy. For example, when the space of controlled evolution rates is given as numeric intervals (say an evolution rate associated with a link l during the time period (01/10/2003, 03/01/2003) is specified to be between 30 and 50 employees per month) then the problem of identifying the optimal cost of operation is formulated as a linear programming problem, where the controlled evolution rates serve as variables of the linear programming problem.

The invention provides a method and apparatus for modeling and computing the costs, penalties, benefits, and other considerations of changing the workforce evolution network topology by adding or destroying one or more skill level/job groups or one or more evolution links. Such an analysis may be conducted for the purpose of achieving the following goals:
1. Identifying which new achievable states are created as a result of changing the workforce network topology.
2. Identifying what is the new operating cost as a result of changing the workforce network topology.

The computation of changing of the set of achievable states is conducted in several steps:
1. Formulating a workforce evolution model.
2. Identifying one or more time periods of interest.
3. Populating the model with evolution rates data.
4. Identifying the present state.
5. Identifying the potential changes in the network topology (added/deleted skill level/job groups, added/deleted links)
6. Computation of the new set of achievable state(s) for the updated network topology.

The first four steps are performed in exactly the same manner as for Computing the Achievable States method, described above. In the fifth step, the changes of the network topology are specified. For example a new skill level/job group C is introduced with a hire link pointing to it (meaning hiring external employees is considered into this group) and a link pointing from this group into some other group D is introduced (meaning people will be considered for a promotion or for a promotion with a shift of a job role from the group C into the group D). In the sixth step, the set of achievable states is computed using the method Computing the Achievable States, but for the network topology obtained as a result of the changes performed in the fifth step. The new set of achievable states can then be compared with the existing ones for the purpose of evaluating the benefit of the considered changes in the topology of the network.

The process of Computing the New Operating Cost comprises the following steps:
1. Formulating a workforce evolution model.
2. Identifying one or more time periods of interest.
3. Populating the model with evolution rates data.
4. Identifying the present state.
5. Identifying the potential changes in the network topology (new/deleted skill level/job groups, new/deleted links)
6. Computation of the new cost of operating the workforce evolution network over the specified period(s) of time.

The first five steps are performed in exactly the same manner as for Computing the New Achievable States method, described above. In the sixth step, the new operating or optimal operating cost is computed using the method Computing the Cost of Operating a Workforce Evolution Network or the method Determining the Optimal Cost of Operating a Workforce Evolution Network, both described above. The resulting cost of operating the workforce network can then be compared with the existing cost for the purpose of evaluating the benefit of the considered changes in the topology of the network.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A computer implemented method for designing and planning workforce evolution comprising the steps of:
identifying a portfolio of candidate workforce organizational topologies;
comparing said candidate topologies for suitability of employment against a mix of workforce topological internal and external constraints; and
defining criteria for selection of at least one candidate topology for a specified mix of internal and external constraints.

2. The computer implemented method according to claim 1, further comprising the step of identifying an original workforce organizational topology, said topology specifying viable paths from one node to another in the workforce organizational topology.

3. The computer implemented method according to claim 2, wherein the workforce organizational topology has a tree structure.

4. The computer implemented method according to claim 2, wherein the workforce organization topology has a grid structure.

5. The computer implemented method according to claim 2, wherein the workforce organization topology has a star structure.

6. The computer implemented method according to claim 2, wherein the workforce organization topology has a cluster structure.

7. The computer implemented method for designing and planning workforce evolution recited in claim 1, wherein the step of defining criteria for selection of at least one candidate topology comprises the steps of:
computing a cost as a function of candidate topologies; and
selecting an optimal topology by finding the topology which minimizes the cost among the space of topologies satisfying the constraints.

8. The computer implemented method for designing and planning workforce evolution recited in claim 7, further comprising the step of characterizing the workforce evolution over time as a function of dynamic workforce events.

9. The computer implemented method for designing and planning workforce evolution recited in claim 8, wherein the step of characterizing the workforce evolution over time comprises the steps of:
identifying one or more time periods of interest;
populating the model with evolution rates data;
identifying a present state; and
computing an achievable state of the workforce.

10. The computer implemented method for designing and planning workforce evolution recited in claim 8, wherein the dynamic workforce events comprise intra-workforce events, wherein the intra-workforce events comprise transitions within the workforce, including promotions, demotions and transfers, and inter-workforce events, wherein the inter-workforce events comprise arrivals to the workforce and departures from the workforce.

11. The computer implemented method for designing and planning workforce evolution recited in claim 1, further comprising the step of identifying feasibility of target states of the workforce.

12. The computer implemented method for designing and planning workforce evolution recited in claim 11, wherein the step of identifying feasibility of target states comprises the steps of:
identifying one or more target states;
computing achievable states and checking whether the achievable states are one of the target states; and
identifying a space of controlled evolution rates and computing elements of the space of controlled evolution rates, which after implementation would result in one of the target states, or identifying that no such element of the space of controlled evolution rates exists.

13. The computer implemented method for designing and planning workforce evolution recited in claim 1, further comprising the step of computing a cost of operating a workforce evolution network.

14. The computer implemented method for designing and planning workforce evolution recited in claim 13, wherein the step of computing a cost of operating a workforce evolution network comprises the steps of:
formulating a workforce evolution model;
identifying one or more time periods of interest;
populating the model with evolution rates data and cost data;
identifying a present state; and
computing a cost of operating the network over the time periods of interest.

15. The computer implemented method for designing and planning workforce evolution recited in claim 14, wherein the step of computing a cost of operating the network computes an optimal cost of operating the network over the time periods of interest and identifies a policy which achieves the optimal cost of operation.

16. The computer implemented method for designing and planning workforce evolution recited in claim 15, wherein the optimal cost of operating the network is computed by means of an enumerative computations method consisting of exhaustively considering every element of the space of controlled evolution rates, fixing it as a numerical value for evolution rates and computing an associated cost of operating the network under a considered vector of evolution rates.

17. The computer implemented method for designing and planning workforce evolution recited in claim 15, wherein the optimal cost of operating the network is computed by means of optimization methods of identifying the optimal cost or operating the workforce network and identifying an optimal policy using mathematical optimization techniques.

18. The computer implemented method for designing and planning workforce evolution recited in claim 14, wherein when transition rates for links of the workforce evolution network are given by numerical network, the cost of operating the network comprises the steps of:
computing achievable states for each end point of time periods considered;
computing for time periods cost corresponding the achievable state at the beginning and at the end of the period;
computing an average of two resulting values and multiplying by a length of the period; and
summing the averages over all the considered time periods.

19. The computer implemented method for designing and planning workforce evolution recited in claim 14, wherein when the transition rates for the links of the workforce evolution network are given by probability distribution functions, the cost of operating the network is obtained using a fluid models based method wherein for each of link of the workforce network and a corresponding probability distribution of an evolution rate, the expected value of the evolution rate is computed and the expected values are then taken as numerical values for the evolution rates and a corresponding cost of operating the network is computed.

20. The computer implemented method for designing and planning workforce evolution recited in claim 14, wherein in when the transition rates for the links of the workforce evolution network are given by probability distribution functions, the cost of operating the network is obtained using a convolution method based computation of the cost by constructing a distribution function of a vector of transition rates for each of the considered time periods using the distribution functions of the rates of individual links corresponding to the considered time periods, then computing a convolution function of these vector distribution functions corresponding to the end of each periods resulting in the distribution function of the state of the network at the end of each time period as well as the joint distribution of the state of the system over all the end points of the considered periods.

21. A computer system implementing a method for designing and planning workforce evolution comprising:
a human resources data base storing data pertaining to skill levels within a plurality of job groups;
a query layer for accessing the human resources data base and one or more external data bases;
a job extraction function, a transitions extraction function and a current state extraction function accessing the human resources data base and one or more external data bases through said query layer;
a model formulation layer identifying a portfolio of candidate workforce organizational topologies to generate model data; and
and a solution layer comparing said candidate topologies for suitability of employment against a mix of workforce topological internal and external constraints and defining criteria for selection of at least one candidate topology for a specified mix of internal and external constraints.

22. The computer system implementing a method for designing and planning workforce evolution recited in claim 21, wherein the human resources data base and said one or more external data bases are geographically distributed and accessible by a global network.

23. The computer system implementing a method for designing and planning workforce evolution recited in claim 22, wherein the global network is the Internet and the query layer includes a browser.

24. The computer system implementing a method for designing and planning workforce evolution recited in claim 23, wherein job extraction function, the transitions extraction function, the current state extraction function, the model formulation layer, and the solution layer are comprised of a server having one or more clients attached.

25. The computer system for implementing a method for designing and planning workforce evolution recited in claim 21, wherein the solution layer defines criteria for selection of at least one candidate topology by computing a cost as a function of candidate topologies and selecting an optimal topology by finding the topology which minimizes the cost among the space of topologies satisfying the constraints.

26. The computer system for implementing a method for designing and planning workforce evolution recited in claim 21, wherein the solution layer identifies one or more target states, computes achievable states and checks whether the achievable states are one of the target states, and identifies a space of controlled evolution rates and computing elements of the space of controlled evolution rates, which after implementation would result in one of the target states, or identifying that no such element of the space of controlled evolution rates exists.

27. The computer system for implementing a method for designing and planning workforce evolution recited in claim 21, wherein the solution layer computes a cost of operating a workforce evolution network by formulating a workforce evolution model, identifying one or more time periods of interest, populating the model with evolution rates data and cost data, identifying a present state, and computing a cost of operating the network over the time periods of interest.
